(19) United States
(12) Patent Application Publication
(10) Pub. No.: US 2008/0265564 A1
(43) Pub. Date: Oct. 30, 2008

(54) Multi-chamber vacuum insulated pipe systems and methods

(76) Inventor: Rod Thomas, Earth City, MO (US)

Correspondence Address: LATHROP & GAGE LC, 4845 PEARL EAST CIRCLE, SUITE 300, BOULDER, CO, 80301, US

(21) Appl. No.: 12/109,108

(22) Filed: Apr. 24, 2008

Related U.S. Application Data
(60) Provisional application No. 60/913,727, filed on Apr. 24, 2007.
(60) Provisional application No. 60/939,070, filed on May 20, 2007.

(51) Int. Cl. F16L 59/065; F16L 59/06

(52) U.S. Cl. 285/47; 138/149

(57) ABSTRACT

Insulated piping and methods of making and using insulated piping are disclosed herein. An insulated pipe according to one embodiment includes a plurality of elongate pipe sections. Each pipe section includes first and second ends, an inner pipe for transporting temperature sensitive fluids, an intermediate pipe extending around the inner pipe, and an outer pipe extending around the inner pipe and the intermediate pipe. The inner pipe is operatively coupled to the outer pipe to form an airtight insulation space between the inner and outer pipes, and the intermediate pipe segregates the airtight insulation space into a plurality of independent insulation spaces between the inner and outer pipes. At least one independent insulation space is radially inward of another independent insulation space.

### RELATED APPLICATIONS

This application claims the benefit of priority to U.S. Provisional Patent Application Ser. Nos. 60/913,727, filed Apr. 24, 2007, and 60/939,070, filed May 20, 2007. Each of these applications is incorporated by reference herein.

### FIELD OF INVENTION

The present disclosure relates generally to insulated piping and, more particularly, to prefabricated multi-chamber vacuum insulated pipe sections and methods for connecting them, for example to provide freeze-free water pipes.

### BACKGROUND

Insulated pipes are used in a wide variety of industrial applications to prevent thermal leakage. For example, thermally insulated piping is used to transport cryogenic liquids. There are three types of commonly used insulated piping: foam insulated copper pipe, dynamic vacuum insulated pipe and static vacuum insulated pipe.

Foam insulated copper pipe is one type of prefabricated pipe with sections constructed of copper surrounded by foam insulation. While foam insulated copper pipe is cost efficient, it may not perform well under extreme conditions. The foam insulation is surrounded and protected by a plastic casing; however over time the insulation tends to absorb water from the atmosphere. As the insulation absorbs water it becomes less efficient and new insulation is required. Sections of foam insulated copper pipe are typically joined by brazing or butt-welding and foam insulation is fitted around the joint.

Dynamic vacuum insulated pipe requires a vacuum system that is continuously running. While this pipe is more efficient than foam insulated pipe, there is an added cost of frequent pump maintenance and electrical power to run the pump(s). Additionally, if a vacuum pump fails then a whole pipe section may lose its vacuum, and hence its insulating properties becoming extremely inefficient.

Static vacuum insulated pipe is prefabricated and the vacuum is achieved and permanently sealed. One advantage of static insulated pipe is the equipment used to create the vacuum in the factory may be of better quality than equipment deployed in the field for use in a dynamic vacuum pipe. Static vacuum insulated pipe may however be susceptible to puncture; a punctured pipe may lose its vacuum and insulating properties and become extremely inefficient. Thermal loss may also occur at the joints because it is prefabricated and the joints may not be vacuum insulated.

### SUMMARY

A vacuum insulated pipe according to one embodiment includes a plurality of pipe sections and at least one insulated pipe connector, and the plurality of insulated pipe sections are connected together by the one or more insulated pipe connectors. Each insulated pipe section has an outer pipe and an inner pipe generally concentric to the outer pipe for transporting temperature sensitive fluids. The outer and inner pipes form a first evacuated insulation space. A first end plate is included for sealing a first end of the first evacuated insulation space, and a second end plate is included for sealing a second end of the first evacuated insulation space. Each insulated pipe connector has an outer pipe and an inner pipe generally concentric to the connector outer pipe. The outer and inner connector pipes form a second evacuated insulation space. A first end plate is included for sealing a first end of the second evacuated insulation space, and a second end plate is included for sealing a second end of the second evacuated insulation space.

A vacuum insulated pipe section according to one embodiment includes an inner pipe for transporting temperature sensitive fluids and an outer pipe extending around the inner pipe. An evacuated insulation space is between the outer and inner pipes. A first end plate seals at least a portion of a first end of the insulation space, and a second end plate seals at least a portion of a second end of the insulation space. The outer pipe extends beyond the inner pipe in a first direction, and female threads are formed inside the outer pipe beyond the first end plate. The inner pipe extends beyond the outer pipe in a second direction, and male threads are formed outside the inner pipe beyond the outer pipe for coupling to female threads of another vacuum insulated pipe section.

An insulated pipe according to one embodiment includes a plurality of elongate pipe sections. Each pipe section includes first and second ends, an inner pipe for transporting temperature sensitive fluids, an intermediate pipe extending around the inner pipe, and an outer pipe extending around the inner pipe and the intermediate pipe. The inner pipe is operatively coupled to the outer pipe to form an airtight insulation space between the inner and outer pipes, and the intermediate pipe segregates the airtight insulation space into a plurality of independent insulation spaces between the inner and outer pipes. At least one independent insulation space is radially inward of another independent insulation space.

### BRIEF DESCRIPTION OF THE FIGURES

FIG. 1A shows an exploded view of a prefabricated insulated pipe section.

FIG. 1B shows a top perspective view of a pipe section.

FIG. 2A shows an exploded view of a pipe joint.

FIG. 2B shows a top perspective view of pipe joint.

FIG. 3 shows an example a pipe system using pipe joints.

FIG. 4A shows cross-section of a pipe section.

FIG. 4B shows a perspective view of a punctured pipe section.

FIG. 5 shows a cross-section of a multi-chamber joint 20.

FIG. 6A and FIG. 6B show pipe sections with male and female threaded inter-connecting ends.

FIG. 7 shows an example of a threaded multi-chamber pipe system.

### DETAILED DESCRIPTION

A multi-chamber vacuum pipe system is described hereinbelow to provide a cost effective puncture-resistant insulated pipe and joint that may be produced and utilized in prefabricated sections. Other advantages will become more apparent in the following detailed description of the inventions.

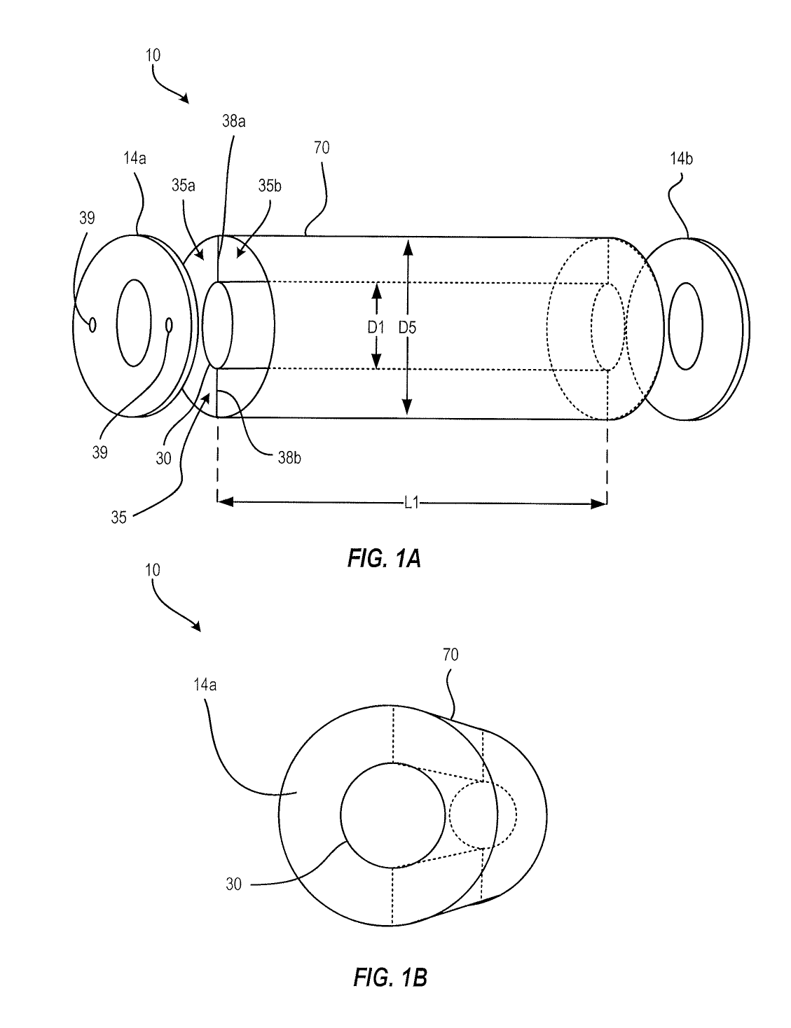

FIG. 1A shows an exploded view of a prefabricated insulated pipe section 10 with an inner pipe 30 for transporting temperature sensitive liquids and a concentric outer pipe 70, positioned such that an annular insulation space 35 is formed therebetween. Annular insulation space 35 is sealed by pipe end plates 14a and 14b at either end of pipes 30 and 70. The annular insulation space may be further dived into two pipe chambers 35a and 35b by chamber walls 38a and 38b, as shown. Outer pipe 70 may be made with thicker material than inner pipe 30 to increase puncture resistance of insulated pipe section 10. Pipe section 10 has a length L1, which may, for example, be between 0.1 m and 10 m, depending upon application. In one embodiment, insulated pipe section 10 is fabricated of hardened plastic; however in other embodiments insulate pipe section 10 may be constructed of ferrous or non-ferrous metal or of a metal plastic hybrid. Insulated pipe section 10 may, for example, be used to transport temperature sensitive liquids within inner pipe 30.

In one exemplary method of construction, outer pipe 70, inner pipe 30 and chamber walls 38a, 38b are formed by extrusion or any other appropriate method. Annular insulation space 35 is, for example, sealed at one end by pipe end plate 14a, air is removed therefrom, and pipe end plate 14b is then attached to seal insulation space 35 and maintain the vacuum therein. Vacuum sealing may occur within a vacuum chamber. Alternately, or additionally, after fitting of pipe end plates 14a, 14b to outer pipe 70, inner pipe 30 and chamber walls 38, one or more small hole 39 in pipe end plate 14a may be used to permit air to be withdrawn from insulation space 35; hole(s) 39 may then be sealed to maintain the vacuum within insulation space 35. The vacuum within insulation space 35 may be created by other means known in the art without departing from the scope hereof.

FIG. 1B shows a top perspective view of pipe section 10, in accord with one embodiment.

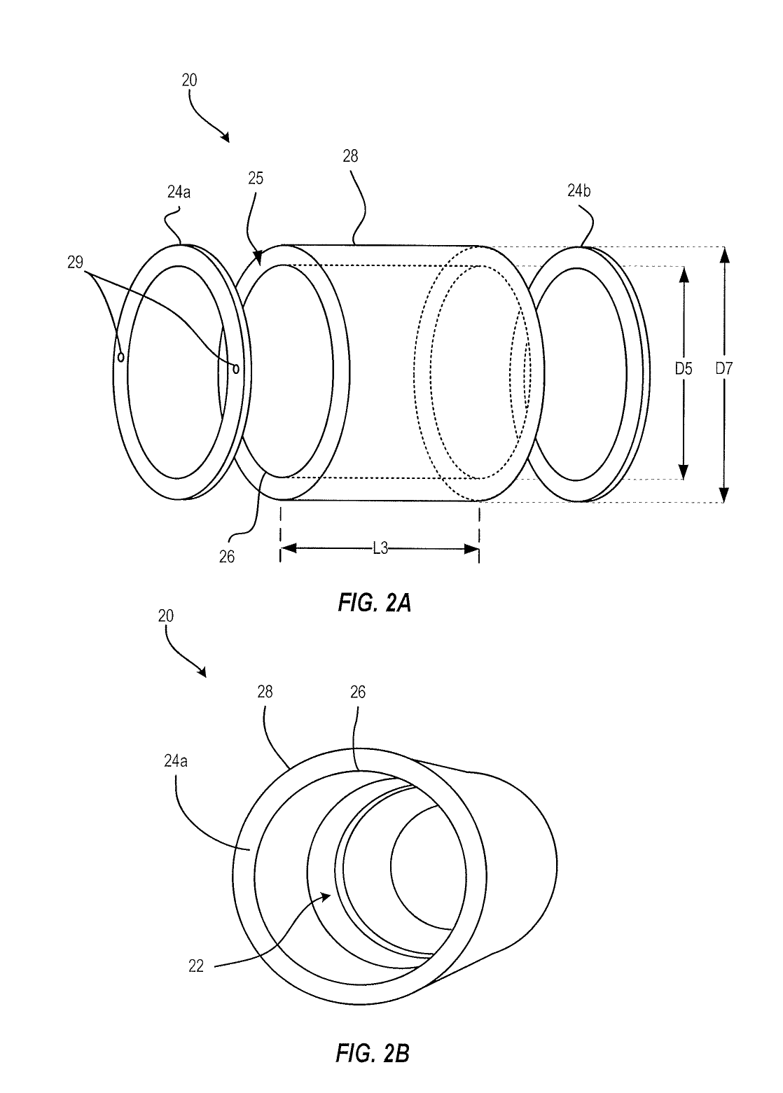

FIG. 2A shows an exploded view of one exemplary embodiment of an insulated pipe joint 20. Pipe joint 20 has an inner pipe 26 and an outer pipe 28 positioned such that an annular insulation space 25 is formed therebetween. Insulation space 25 is sealed by joint end plates 24a and 24b. Pipe joint 20 has a length L3, which may, for example, be between 0.1 m and 0.25 m, depending upon application. Inner pipe 26 has an internal diameter D5 so that pipe section 10 can slide into either side of joint 20 (i.e., through joint end plates 24a and 24b). Though not shown, insulation space 25 may be divided into multiple chambers by chamber walls.

In one exemplary method of construction, outer pipe 28 and inner pipe 26 are formed by extrusion or any other appropriate method. Insulation space 25 is, for example, sealed at one end by joint end plate 24a, air is removed therefrom, and joint end plate 24b is then attached to seal insulation space 25 and maintain the vacuum therein. Vacuum sealing may occur within a vacuum chamber. Alternately, or additionally, after fitting of joint end plates 24a, 24b to outer pipe 28 and inner pipe 26, one or more small hole 29 in joint end plate 24a may be used to permit air to be withdrawn from insulation space 25; hole(s) 29 may then be sealed to maintain the vacuum within insulation space 25. The vacuum within insulation space 25 may be created by other means known in the art without departing from the scope hereof.

FIG. 2B shows a perspective view of pipe joint 20 of FIG. 2A once assembled. Pipe joint 20 may also include a pipe stop 22, as shown in FIG. 2B, that prevents pipe section 10 from passing more than halfway through pipe joint 20 during insertion. Pipe section 10 and pipe joint 20 may be attached using pipe adhesive or other methods known in the art; the method employed may be selected to prevent thermal leakage. Pipe stop 22 may protrude at least partially along the circumference of inner pipe 26 in the center of pipe joint 20. In other embodiments, pipe stop 22 may be formed as a gradual reduction in the diameter of inner pipe 26 towards the center of inner pipe 26.

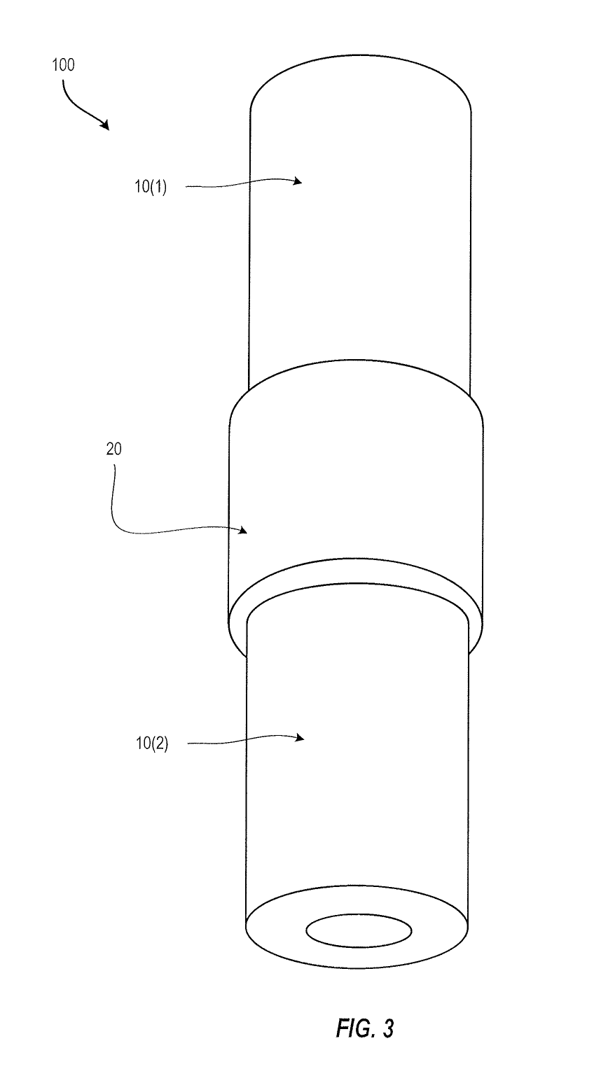

FIG. 3 shows one exemplary pipe system 100 with two pipe sections 10 (labeled 10(1) and 10(2), respectively) and a pipe joint 20. Although shown with two pipe sections 10 and one pipe joint 20, pipe system 100 may contain additional pipe sections 10 and joints 20 to form a longer insulated section of pipe. It should be appreciated that one or more pipe section 10 and/or pipe joint 20 may be nonlinear (e.g., curved, angled, etc.) and that the resultant pipe system may therefore be nonlinear.

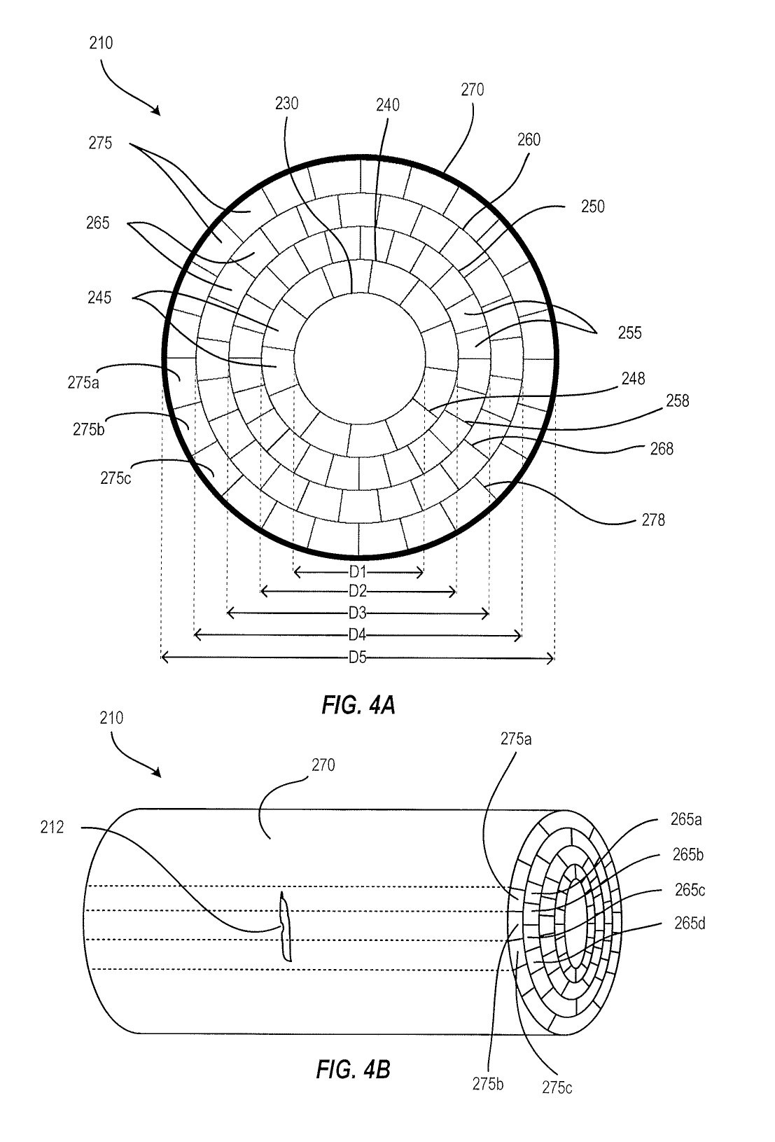

FIG. 4A shows a cross-section through one exemplary embodiment of a pipe section 210. Pipe section 210 may, for example, represent pipe section 10 (FIG. 1A). Pipe section 210 is, for example, formed with an outer pipe 270 and four concentric inner pipes 260, 250, 240, and 230 to form insulating spaces 275, 265, 255, and 245. Pipes 230, 240, 250, 260, and 270 are generally concentric and are shown with diameters D1, D2, D3, D4, and D5, respectively. Insulating spaces 275, 265, 255, and 245 may be divided into sub-spaces by chamber walls 278, 268, 258, and 248, respectively.

Outer pipe 270 may, for example, be made of thicker material than inner pipes 260, 250, 240, and 230 and walls 278, 268, 258, and 248 to increase puncture resistance of pipe section 210. Though not specifically shown, an additional outer casing may be formed around pipe section 210 in increase durability of pipe section 210. Some embodiments may include variation in thickness of inner pipes 260, 250, 240, and 230 and/or walls 278, 268, 258, and 248 without departing from the scope hereof.

Pipe section 210 may include pipe end plates (not shown) that seal insulating spaces 275, 265, 255 and 245; these end plates may, for example, be similar to end plates 14a, 14b of FIG. 1A. Air may be evacuated from insulating spaces 275, 265, 255 and 245 to improve insulation of fluids transported within inner pipe 230. Each sub-space of insulating spaces 275, 265, 255 and 245 (e.g., sub-spaces 275a, 275b, 275c, etc.) may be sealed to prevent fluid flow between sub-spaces. The number of insulating spaces and sub-spaces may vary without departing from the scope hereof. In some embodiments, insulating spaces 275, 265, 255 and 245 have equal vacuum. In other embodiments, vacuum within insulating spaces 275, 265, 255 and 245 varies; for example, vacuum may increase towards the center of pipe section 210.

Pipe section 210 may be rated based upon its insulation properties and the material from which it is constructed. For example, pipe section 210 may be used to transport water through a mountainous environment prone to temperatures 20 degrees Celsius (C) below the freezing point of water and therefore requires that pipe section 210 be rated for −20° C. In another example, pipe section 210 may transport water through an environment that has lesser extremes and therefore need only be rated for −10° C. To achieve lower temperature ratings (e.g., −20° C.), pipe section 210 may have more internal pipes (e.g., internal pipes 230, 240, 250 and 260) and additional sub-spaces within each insulating space (e.g., sub-spaces 275a, 275b, and 275c within insulating space 275). Vacuum properties of pipe section 210 (e.g., gas pressure between the exterior pipe 270 and the inner pipe 230) may also be altered to achieve different temperature ratings.

In some embodiments, pipes 230, 240, 250, 260, and 270 and chamber walls 278, 268, 258, and 248 are formed from plastic using extrusion molding techniques. In other embodiments, outer pipe 270 and insulating spaces 275, 265, 255, and 245 are formed separate from inner pipe 230 and are then later attached to inner pipe 230.

FIG. 4B shows a perspective view of pipe section 210 of FIG. 4A with a puncture 212 that breaches exterior pipe 270. In particular, puncture 212 breaches sub-spaces 275a, 275b, and 275c of insulating space 275, but has not breached pipe 260 or other sub-spaces within insulating space 275. Therefore, in this example, other sub-spaces of insulating space 275, insulating space 265 (e.g., sub-spaces 265a, 265b, 265c and 265d), insulating space 255, and insulating space 245 still maintain a vacuum and provide insulation in the region of puncture 212. Since puncture 212 has only compromised external pipe 270 and sub-spaces 275a, 275b, and 275 of insulating space 275, it may not be necessary to replace pipe section 210 since inner pipe 230 may still be sufficiently insulated.

Since each sub-space within each insulating space may have an individual vacuum, a non-catastrophic puncture (e.g., puncture 212) may not compromise the insulation of pipe section 210. Further, pipe section 210 may tolerate a certain number of chamber failures over a certain distance and still maintain sufficient insulation of inner pipe 230.

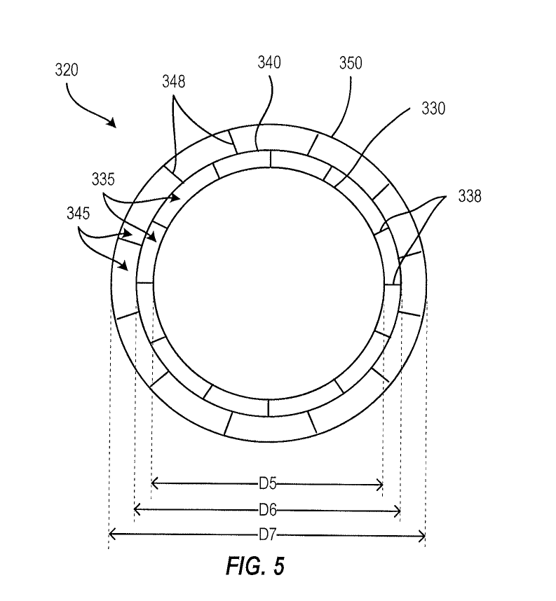

FIG. 5 shows a cross-section through one exemplary embodiment of a pipe joint 320. Pipe joint 320 may, for example, represent pipe joint 20 of FIG. 2A. Pipe joint 320 is shown with three concentric pipes 350, 340, and 330 that form insulating spaces 345 and 335 therebetween. Insulating spaces 345 and 335 are each subdivided into sub-spaces by walls 348 and 338, respectively.

Outer pipe 350 may be made of thicker material to increase puncture resistance; however, pipes 350, 340, and 330 may vary in thickness without departing from the scope hereof. Each sub-space of insulating spaces 335 and 345 may contain a vacuum to increase insulation properties. Since each sub-space may be individually sealed, one or more punctures to outer pipe 350 may not compromise insulation of inner pipe 330.

Concentric joint pipes 340, 350, and 360 have diameters D5, D6, and D7, respectively. The inner diameter D5 of inner pipe 330 allows pipe section 210 to fit therein. In one example, pipe section 210 and joint 320 fit together snugly; force and/or adhesive, for example, may be used to facilitate joining pipe section 210 and pipe joint 320.

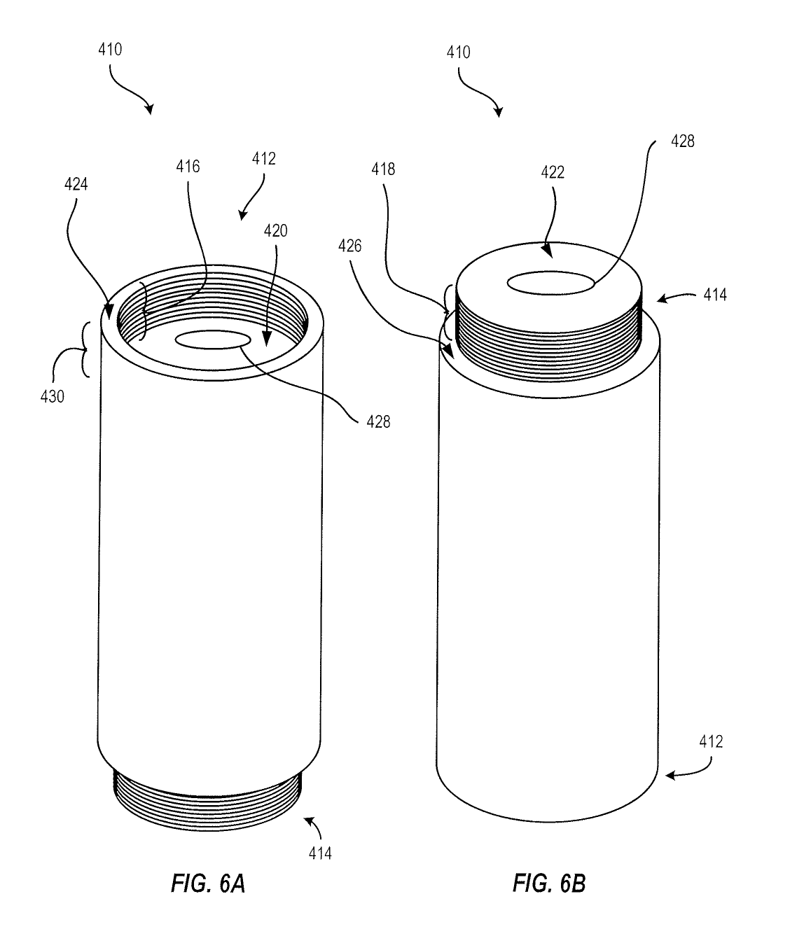

FIG. 6A shows one exemplary embodiment of a pipe section 410 with female 412 and male 414 inter-connecting ends. FIG. 6B shows pipe section 410 inverted for clarity of illustration of male end 414. FIGS. 6A and 6B are best viewed together with the following description.

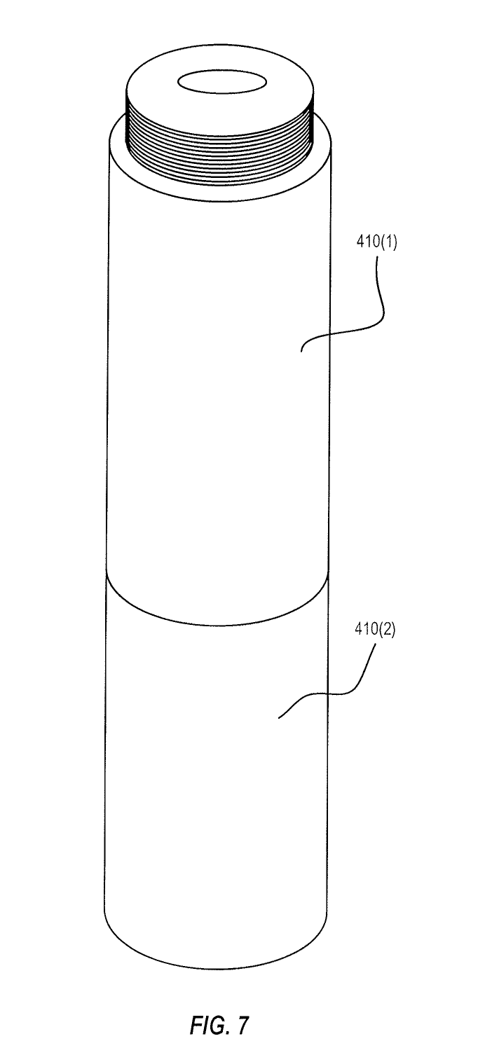

Female end 412 is shown with a female thread 416, and male end 414 is shown with a male thread 418. FIG. 7 shows multiple pipe sections 410 (labeled 410(1) and 410(2), respectively) connected together by threads 416, 418. When so connected, surface 420 and surface 424 of female end 412 (FIG. 6A) meets surface 422 and surface 426 of male end 414 (FIG. 6B), respectively, such that inner pipe 428 allows unimpeded fluid flow between pipe sections. Female thread 416 may, for example, be formed on an inner wall of an outer pipe (e.g., outer pipe 270, FIG. 4A) of a pipe section (e.g., pipe section 210), or may be formed on an inner pipe (e.g., inner pipe 260, FIG. 4A) such as to include insulation (e.g., insulation space 275) around female tread 416. Male thread 418 may be formed upon an external wall of an inner pipe (e.g., inner pipe 260, FIG. 4A) such as to include insulation (e.g., insulating spaces 265, 255, 245) between male thread 418 and inner pipe 428. Thus, when connected (FIG. 7), the insulation properties of multiple pipe sections 410 may be continuous. Adhesive may be used to on threads 418 and/or threads 416 to ensure pipe sections 410 remain connected.

Changes may be made in the above systems and methods without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A vacuum insulated pipe, comprising:
a plurality of insulated pipe sections, each insulated pipe section having:
an outer pipe;
an inner pipe generally concentric to the outer pipe for transporting temperature sensitive fluids, the outer and inner pipes forming a first evacuated insulation space;
a first end plate for sealing a first end of the first evacuated insulation space; and
a second end plate for sealing a second end of the first evacuated insulation space;
at least one insulated pipe connector, each insulated pipe connector having:
an outer pipe;
an inner pipe generally concentric to the connector outer pipe, the outer and inner connector pipes forming a second evacuated insulation space;
a first end plate for sealing a first end of the second evacuated insulation space; and
a second end plate for sealing a second end of the second evacuated insulation space;
wherein the plurality of insulated pipe sections are connected together by the one or more insulated pipe connectors.

2. The vacuum insulated pipe of claim 1, wherein
the first evacuated insulation space includes one or more additional concentric pipes providing a plurality of independent evacuated insulation spaces between the outer pipe and the inner pipe of the insulated pipe section; and
the second evacuated insulation space includes one or more additional concentric pipes providing a plurality of independent evacuated insulation spaces between the outer pipe and the inner pipe of the insulated pipe connector.

3. The vacuum insulated pipe of claim 2, wherein:
at least one of the independent evacuated insulation spaces of the first evacuated insulation space has a different vacuum property than at least one other of the independent evacuated insulation spaces of the first evacuated insulation space; and
at least one of the independent evacuated insulation spaces of the second evacuated insulation space has a different vacuum property than at least one other of the independent evacuated insulation spaces of the second evacuated insulation space.

4. The vacuum insulated pipe of claim 2, wherein at least one of the independent evacuated insulation spaces between the outer pipe and the inner pipe of the insulated pipe section is divided into at least two sub-spaces by at least two walls.

5. The vacuum insulated pipe of claim 4, wherein at least one of the sub-spaces has a different vacuum property than at least one other of the sub-spaces.

6. The vacuum insulated pipe of claim 1, wherein the outer pipe of the pipe section is more durable than the inner pipe of the pipe section to resist puncture through the outer pipe of the pipe section.

7. The vacuum insulated pipe of claim 1, wherein the pipes are fabricated from one or more of the group consisting of plastic, steel, aluminum, and copper.

8. A vacuum insulated pipe section, comprising:
an inner pipe for transporting temperature sensitive fluids;
an outer pipe extending around the inner pipe, an evacuated insulation space being between the outer and inner pipes;
a first end plate sealing at least a portion of a first end of the insulation space; and
a second end plate sealing at least a portion of a second end of the insulation space;
wherein the outer pipe extends beyond the inner pipe in a first direction and female threads are formed inside the outer pipe beyond the first end plate;
wherein the inner pipe extends beyond the outer pipe in a second direction and male threads are formed outside the inner pipe beyond the outer pipe for coupling to female threads of another vacuum insulated pipe section.

9. The vacuum insulated pipe section of claim 8, wherein the evacuated insulation space includes one or more additional concentric pipes providing a plurality of independent evacuated insulation spaces between the outer pipe and the inner pipe.

10. The vacuum insulated pipe section of claim 9, wherein at least one of the independent evacuated insulation spaces has a different vacuum property than at least one other of the independent evacuated insulation spaces.

11. The vacuum insulated pipe section of claim 9, wherein at least one of the independent evacuated insulation spaces is divided into at least two sub-spaces by at least two walls.

12. The vacuum insulated pipe section of claim 11, wherein at least one of the sub-spaces has a different vacuum property than at least one other of the sub-spaces.

13. The vacuum insulated pipe section of claim 8, wherein the outer pipe is more durable than the inner pipe to resist puncture through the outer pipe.

14. The vacuum insulated pipe section of claim 8, wherein the pipes are fabricated from one or more of the group consisting of plastic, steel, aluminum, and copper.

15. The vacuum insulated pipe section of claim 8, wherein:
an evacuated insulation space is formed between the outer pipe and the female threads beyond the inner pipe; and
an evacuated insulation space is formed between the inner pipe and the male threads beyond the outer pipe.

16. The vacuum insulated pipe section of claim 8, wherein the outer pipe extends beyond the inner pipe in the first direction a distance that is generally equal to a distance that the inner pipe extends beyond the outer pipe in the second direction.

17. Insulated pipe comprising a plurality of elongate pipe sections, each pipe section comprising:
first and second ends;
an inner pipe for transporting temperature sensitive fluids;
an intermediate pipe extending around the inner pipe; and
an outer pipe extending around the inner pipe and the intermediate pipe;
wherein the inner pipe is operatively coupled to the outer pipe to form an airtight insulation space between the inner and outer pipes; and
wherein the intermediate pipe segregates the airtight insulation space into a plurality of independent insulation spaces between the inner and outer pipes, at least one independent insulation space being radially inward of another independent insulation space.

18. The insulated pipe of claim 17, wherein each airtight insulation space has an air pressure that is less than atmospheric pressure.

19. The insulated pipe of claim 17, wherein at least one independent insulation space has an air pressure that is less than atmospheric pressure.

20. The insulated pipe of claim 19, wherein an independent insulation space between the outer and intermediate pipes is further segregated into a plurality of sub-spaces by at least two walls.

21. The pipe of claim 19, wherein:
each first end includes a male thread; and
each second end includes a female thread for coupling to a respective male thread of another pipe section.

22. The pipe of claim 19, further comprising:
an insulated pipe connector having:
first and second ends;
an inner pipe; and
an outer pipe extending around the inner pipe of the connector;
wherein the inner pipe of the connector is operatively coupled to the outer pipe of the connector to form an airtight insulation space between the inner and outer pipes of the connector;
wherein a first respective pipe section is inserted inside the insulated pipe connector at the insulated pipe connector first end; and
wherein a second respective pipe section is inserted inside the insulated pipe connector at the insulated pipe connector second end to allow fluid to flow between the first and second respective pipe sections without escaping therebetween.
